(19) United States
(12) Patent Application Publication
(10) Pub. No.: US 2008/0116673 A1
(43) Pub. Date: May 22, 2008

(54) Vent hole module of air bag

(76) Inventor: Yong Sun Kim, Namyangju-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,724

(22) Filed: Dec. 29, 2006

(30) Foreign Application Priority Data
Nov. 21, 2006 (KR) 10-2006-0115197

(51) Int. Cl. B60R 21/276

(52) U.S. Cl. 280/742

(57) ABSTRACT

A vent hole module of an airbag includes a vent hole on the airbag and configured to exhaust gas from the airbag; an air bag attaching portion attached to the airbag near the vent hole; and a vent hole cover for covering the vent hole, removably attached to the air bag attaching portion. The vent hole cover opens the vent hole when a pressure in the air bag is greater than a target pressure. The vent hole cover may include a cover attaching portion removably attached to the air bag attaching portion. The air bag attaching portion and the cover attaching portion may include a hook-and-loop fastener. A connecting portion may further be provided, attached to the vent hole cover and to the airbag, preventing the vent hole cover from being completely removed from the air bag.

### CROSS-REFERENCE TO RELATED APPLICATION

This application claims priority to and the benefit of Korean Patent Application No. 10-2006-0115197 filed in the Korean Intellectual Property Office on Nov. 21, 2006, the entire contents of which are incorporated herein by reference.

### BACKGROUND OF THE INVENTION

(a) Field of the Invention

The present invention relates to a vent hole module of an air bag. More particularly, the present invention relates to a vent hole module of an air bag that improves stability of an occupant regardless of a capacity of an inflator since a gas in the air bag cannot be exhausted if pressure in the air bag is smaller than or equal to a predetermined target pressure.

(b) Description of the Related Art

A conventional air bag apparatus includes an inflator mounted at a middle portion of an air bag and vent holes provided at side portions of the air bag. The inflator inflates the airbag upon receiving an accident signal from an air bag control unit (ACU). The vent hole exhausts the gas of the air bag and maintains the pressure in the air bag within a predetermined range.

Operation of the air bag apparatus is controlled according to collision type and collision speed. Generally, the time from when a collision occurs to when the ACU determines that the collision has occurred is 10-30 ms, and the time from when the collision signal is generated to when the air bag expands fully is 30-40 ms.

For a 110-130 liter airbag, an inflator that supplies a pressure of more than 440 kPa must be used to meet regulations. As the inflator pressure increases, the chances of serious injury increase in the case of a low risk deployment, but the chances of serious injury decrease in the case of a collision.

Therefore, for low risk deployments, an inflator that supplies a pressure less than 400 kPa can be used. However, in the case of a collision, an inflator that supplies a pressure less than 400 kPa cannot be used.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a vent hole module of an air bag having the advantage that stability of an occupant is improved regardless of a capacity of an inflator when a collision occurs.

A vent hole module of an air bag according to an exemplary embodiment of the present invention includes a vent hole for exhausting a gas in an air bag; an air bag attaching portion attached around the vent hole; and a vent hole cover for covering the vent hole. The vent hole cover is attached to the air bag attaching portion, and opens the vent hole when a pressure in the air bag is larger than a target pressure.

The vent hole cover may include a cover attaching portion that is attached to the air bag attaching portion.

The air bag attaching portion and the cover attaching portion may be made of a hook-and-loop (Velcro) tape.

The target pressure may be controlled by selecting an appropriate length of the Velcro tape.

The vent hole module may further include a connecting portion preventing the vent hole cover from being completely separated from the air bag.

### BRIEF DESCRIPTION OF THE DRAWINGS

FIG. 1 is a schematic front view of a vent hole module of an air bag according to an exemplary embodiment of the present invention.

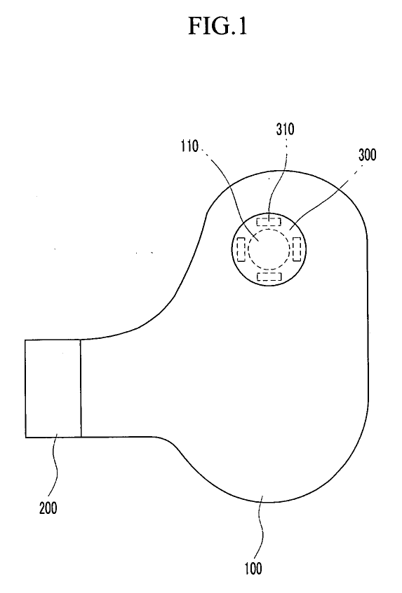

FIG. 2 is a schematic rear view of a vent hole cover according to an exemplary embodiment of the present invention.

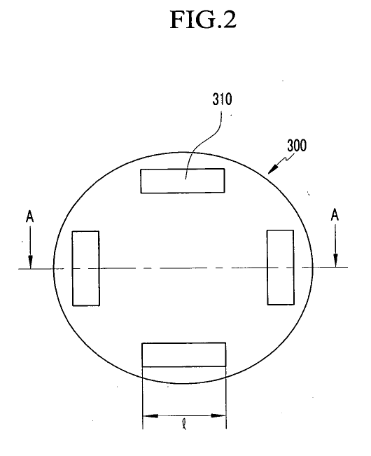

FIG. 3 is a cross-sectional view along the line A-A of FIG. 2.

### DETAILED DESCRIPTION OF THE PREFERRED EMBODIMENTS

An exemplary embodiment of the present invention will hereinafter be described in detail with reference to the accompanying drawings.

A vent hole module of an air bag according to an exemplary embodiment of the present invention is mounted on an air bag 100. The air bag 100 is provided with an inflator 200. The inflator 200 inflates the airbag 100 upon receiving an accident signal from an air bag control unit (not shown).

The vent hole module of the air bag according to an exemplary embodiment of the present invention includes a vent hole 10, an air bag attaching portion 120, a vent hole cover 300, and a connecting portion 320.

The vent hole 110 exhausts the gas in the air bag 100 when the air bag 100 expands by receiving the gas from the inflator 200.

The air bag attaching portion 120 is attached around the vent hole 10, such as by being sewn to the air bag 100.

The vent hole cover 300 is attached to the air bag attaching portion 120. The vent hole cover 300 may be made, for example, of fiber or vinyl. The vent hole cover 300 covers the vent hole 110 and prevent the gas in the air bag 100 from being exhausted in a normal state. However, the vent hole cover 300 opens the vent hole 10 when a pressure in the air bag 100 is larger than a target pressure.

A cover attaching portion 310 is attached to a rear surface of the vent hole cover 300, such as by being sewn to the vent hole cover 300.

The cover attaching portion 310 is removably attached to the air bag attaching portion 120 by any material that facilitates attachment and detachment, such as by a hook-and-loop (Velcro) tape.

Adherence strength of the Velcro tape increases with length of,the Velcro tape. Therefore, the target pressure at which the vent hole 110 is opened can be controlled by selecting an appropriate length of the Velcro tape.

The connecting portion 320 connects the vent hole cover 300 to the air bag 100. When the cover attaching portion 310 is detached from the air bag attaching portion 120, the connecting portion 320 prevents the vent hole cover 300 from being completely separated from the air bag 100.

Hereinafter, operation of the vent hole module according to the exemplary embodiment of the present invention will be described.

In the normal state, the vent hole cover 300 covers the vent hole 110. In this state, if an accident occurs, the inflator 200 inflates the air bag 100, increasing the pressure in the air bag 100.

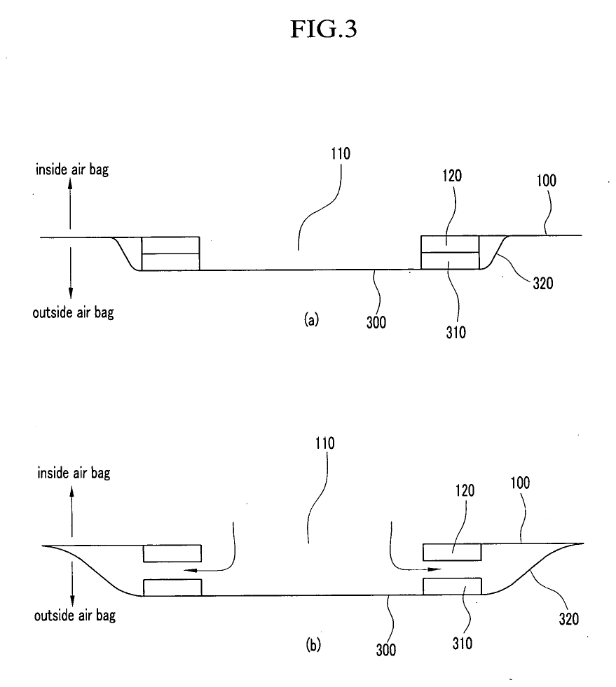

As shown in FIG. 3A, if the pressure in the air bag 100 is less than or equal to the target pressure, the cover attaching portion 310 remains attached to the air bag attaching portion 120, and thus, the vent hole cover 300 still covers the vent hole 110. Therefore, the gas is not exhausted through the vent hole 110.

As shown in FIG. 3B, if the pressure in the air bag 100 is greater than the target pressure, the cover attaching portion 310 is detached from the air bag attaching portion 120, and the vent hole 110 is opened. Therefore, the gas is exhausted through the vent hole 110 and the pressure in the air bag 100 is controlled.

In this case, the connecting portion 320 connects the vent hole cover 300 to the air bag 100 in order to prevent the vent hole cover 300 from being completely separated from the air bag 100.

As described above, according to the present invention, stability of occupants may be improved regardless of a capacity of an inflator since the gas is not exhausted if the pressure in the air bag is less than or equal to the target pressure. In addition, the target pressure may be easily controlled by selecting an appropriate length of Velcro tape.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vent hole module of an airbag, comprising:
a vent hole on the airbag and configured to exhaust gas from the airbag;
an air bag attaching portion attached to the airbag near the vent hole; and
a vent hole cover for covering the vent hole, removably attached to the air bag attaching portion;
wherein the vent hole cover opens the vent hole when a pressure in the air bag is greater than a target pressure.

2. The vent hole module of claim 1, wherein the vent hole cover comprises a cover attaching portion removably attached to the air bag attaching portion.

3. The vent hole module of claim 2, wherein the air bag attaching portion and the cover attaching portion comprise a hook-and-loop fastener.

4. The vent hole module of claim 1, further comprises a connecting portion attached to the vent hole cover and to the airbag, preventing the vent hole cover from being completely removed from the air bag.
